(19) United States
(12) Patent Application Publication
(10) Pub. No.: US 2003/0165094 A1
(43) Pub. Date: Sep. 4, 2003

(54) Method for adjusting the writing speed of data recording device

(76) Inventors: Hsien-Yu Tseng, Taipei (TW); Shih-Chieh Lee, Ilan (TW); Ching-Hwa Liu, Taipei (TW)

Correspondence Address: BIRCH STEWART KOLASCH & BIRCH, PO BOX 747, FALLS CHURCH, VA, 22040-0747, US

(21) Appl. No.: 10/376,321

(22) Filed: Mar. 3, 2003

(30) Foreign Application Priority Data
Mar. 4, 2002 (TW) 091103935

(51) Int. Cl. G11B 7/00

(52) U.S. Cl. 369/47.3; 369/53.36; 369/47.44

(57) ABSTRACT

A method for adjusting the writing speed of a data recording device. First, recording media is written to at a writing speed, the Absolute Time In Pregroove Error Rate (ATER) is calculated according to the error codes occurring in Absolute Time In Pregroove (ATIP) on the recording media when writing to the recording media. Then, the writing speed is adjusted according to the Absolute Time In Pregroove Error Rate (ATER) until writing to the recording media is finished.

### BACKGROUND OF THE INVENTION

1. Field of the Invention

The present invention relates to a method for adjusting the writing speed of data recording devices, and particularly to a method for adjusting the writing speed of data recording devices that dynamically adjusts the writing speed according to the Absolute Time In Pregroove Error Rate (ATIP Error Rate, ATER) of recording media.

2. Description of the Related Art

Recently, optical storage media, such as compact disc (CD) and recordable compact disc (CD-R and CD-RW) has a significant standing in the evolution of data storage. With the development of optical storage media, data can be recorded and backed up into high capacity and light discs, and the optical storage media will take the place of traditional data storage media.

FIG. 1 shows the block diagram of a disc servo system. The optical head 11 reads reflection signal from the disc 10. After the signal is amplified and processed by the RF (Radio Frequency) IC 12, the FE (Focus Error) signal, TE (Track Error) signal and relative data and signals are input to DSP (Digital Signal Processor) and micro processor 13.

Then, the micro processor 13 computes servo driver signals by analyzing the received data, and outputs the signals to corresponding servos (Focusing Servo 14, Tracking Servo 15 and spindle Motor Servo 16) for controlling the actuators (focusing actuator 17, tracking actuator 18, sled motor 19 and spindle rotor 20) to ensure the accuracy when reading or writing (recording) data.

In the process of writing recordable discs, the data recording device always gradually raises its writing speed from slower speed to the maximum writing speed or user defined speed according to the predetermined time regions. FIG. 2 shows the variation of writing speed of conventional data recording devices. As shown in FIG. 2, the writing speed is 16 in the time region 0˜t1, the writing speed is raised from 16 to 20 in the time region t1˜t2, the writing speed is raised from 20 to 24 in the time region t2˜t3, and after time t3, the writing speed is raised from 16 to the maximum writing speed 32 and maintained until the recording finishes.

A blank disc is preformatted with wobble signals and time code information known as Absolute Time In Pregroove (ATIP). The wobble signals can be used to control the CD ROM's rotation speed. This time information allows a CD burner to easily locate and access the various different regions on the blank disc and to locate the end of the previous recording so that a new track can be written. That is, both the wobble signals and ATIP can be used to help the data recording device in controlling its rotation speed and optical head in tracking. When the data recording device starts to write data, the laser of the data recording device will follow the pregroove and maintain stable writing speed according to the frequency (wobble signal and ATIP) recorded in the pregroove. Finally, the frequency will be replaced by the data track.

Since the data is successively stored on the disc, the writing process of the data recording device must be continuous and no interrupt is allowable. If only one link breaks down, the writing process fails, thus the recordable disc has to be discarded. One reason for writing failure is the occurrence of error codes in ATIP. Since ATIP is used to help the optical head in tracking, the optical head will write data at deviation position if error codes occurs in ATIP.

However, there is no effective mechanism to solve the problem of error codes occurring in ATIP for all types of recording media. The quality of writing to recording media can also be ensured.

### SUMMARY OF THE INVENTION

It is therefore an object of the present invention to provide a method for adjusting the writing speed of data recording devices that dynamically adjusts the writing speed according to the Absolute Time In Pregroove Error Rate (ATIP Error Rate, ATER) of recording media.

To achieve the above object, a method for adjusting the writing speed of data recording devices according to the embodiment of the invention is provided. First, recording media is written to at a first writing speed. Then, the Absolute Time In Pregroove Error Rate (ATER) is calculated according to the error codes occurring in Absolute Time In Pregroove (ATIP) on the recording media. If the ATER is larger than a predetermined value, the first writing speed is decreased to a second writing speed, and then the recording media is written to at the second writing speed.

Further, if the ATER is not larger than the predetermined value in a predetermined time region, the first writing speed is raised to a third writing speed, and then the recording media is written to at the third writing speed.

According to the embodiment, the data recording device may be CD-R ROM or CD-RW ROM, and the recording media may be CD-R or CD-RW.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a block diagram showing the system architecture of a disc servo system;

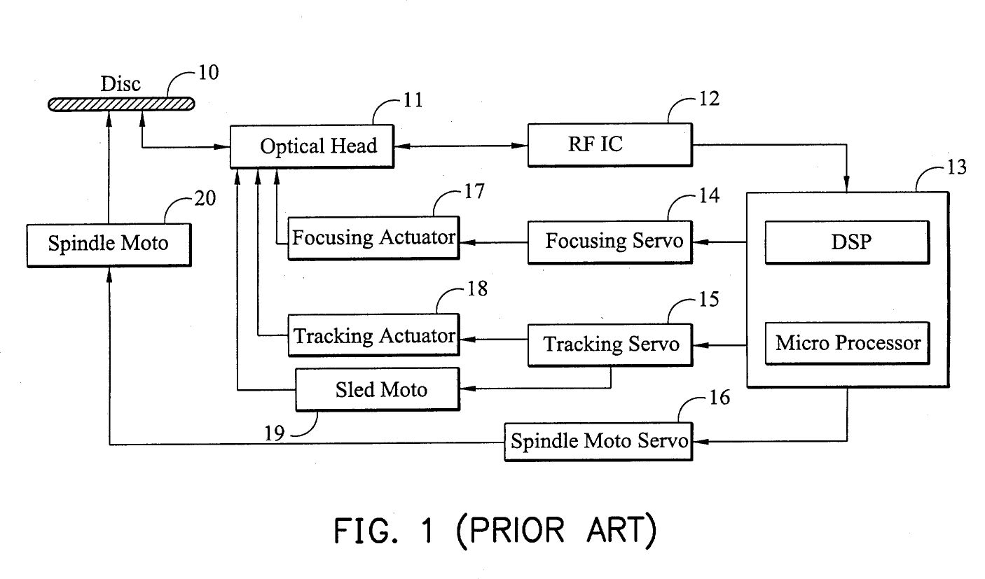

FIG. 2 shows the variation of writing speed of conventional data recording devices;

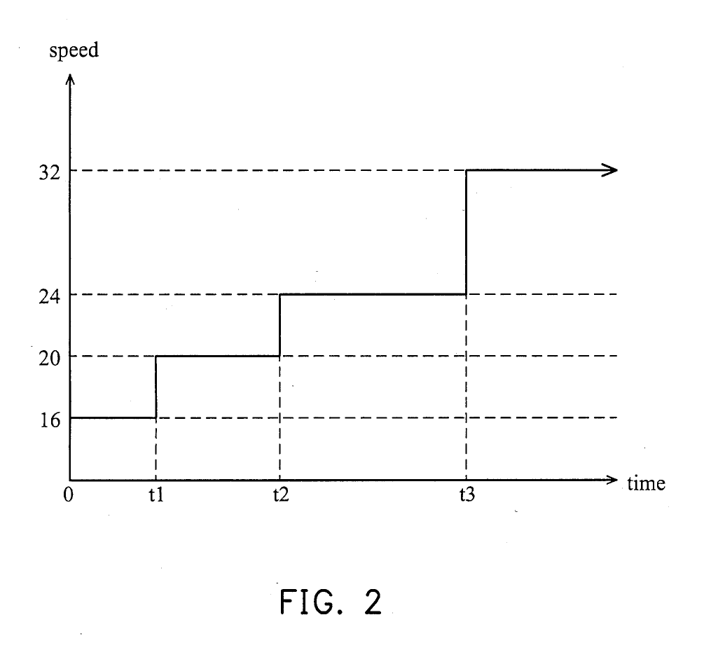

FIG. 3 is a flow chart illustrating the operation of a method for adjusting the writing speed of data recording devices according to the embodiment of the present invention; and

FIG. 4 is an example showing the variation of writing speed of data recording devices according to the embodiment of the present invention.

### DETAILED DESCRIPTION OF THE PREFERRED EMBODIMENT

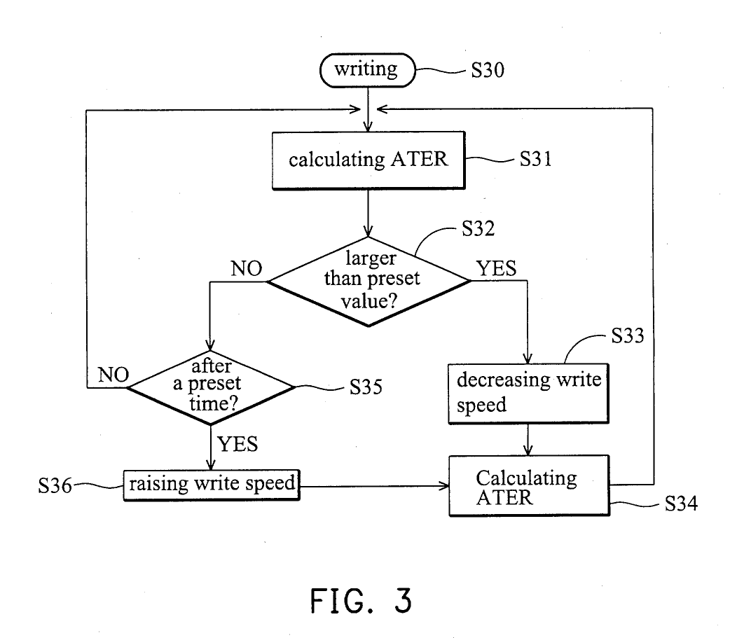

FIG. 3 shows the operation of a method for adjusting the writing speed of data recording devices according to the embodiment of the present invention. The method for adjusting the writing speed of data recording devices according to the embodiment of the present invention is suitable for use in data recording devices, such as CD-R ROMs and CD-RW ROMs.

First, in step S30, recording media is written to at a first writing speed. The recording media may be a CD-R or CD-RW. Then, in step S31, the Absolute Time In Pregroove Error Rate (ATER) is calculated according to the error codes occurred in Absolute Time In Pregroove (ATIP) on the recording media.

Then, in step S32, the Absolute Time In Pregroove Error Rate (ATER) is compared a predetermined value. If the Absolute Time In Pregroove Error Rate (ATER) is larger than the predetermined value (YES in step S32), the first writing speed is decreased to a second writing speed (step S33), and the Absolute Time In Pregroove Error Rate (ATER) is reset (step S34). Afterward, the data recording device writes to the recording media at the second writing speed.

If the Absolute Time In Pregroove Error Rate (ATER) is not larger than the predetermined value (NO in step S32), it is further determined whether the condition that (ATER) is not larger than the predetermined value can be maintained over a predetermined time period (step S35). If the condition cannot be maintained over the predetermined time period, the flow will return to step S31 and continue to to calculate the Absolute Time In Pregroove Error Rate (ATER). If the condition can be maintained over the predetermined time period, the first writing speed is raised to a third writing speed (step S36), and then the Absolute Time In Pregroove Error Rate (ATER) is reset (step S34). Afterward, the data recording device writes the recording media at the third writing speed.

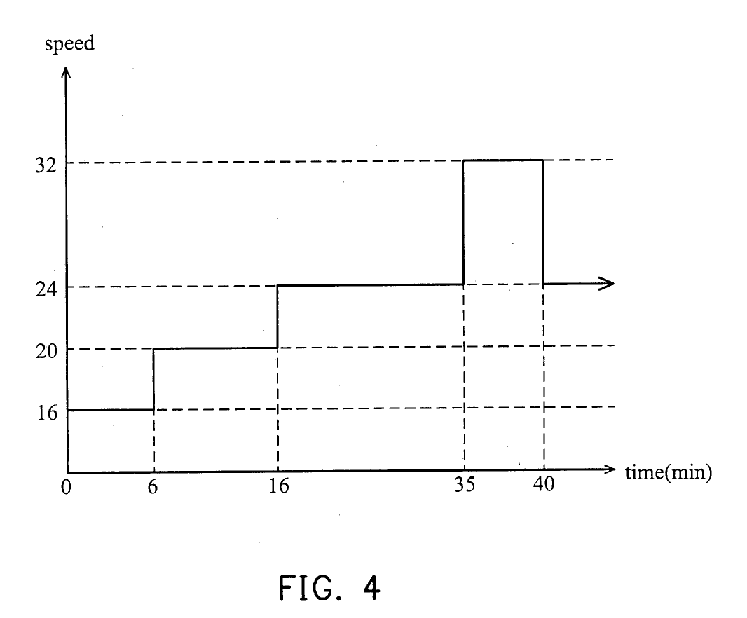

FIG. 4 is an example showing the variation of writing speed of data recording devices according to the embodiment of the present invention.

At first, the data recording device writes to the recording media at a writing speed of 16. Since the Absolute Time In Pregroove Error Rate (ATER) is not larger than the predetermined value, the writing speed of the data recording device is raised to 20, and the Absolute Time In Pregroove Error Rate (ATER) is reset to 0. Afterward, the data recording device start to writes to the recording media at the writing speed of 20.

Thereafter, since the Absolute Time In Pregroove Error Rate (ATER) is not larger than the predetermined value when writing to the recording media at the writing speed of 20, the writing speed of the data recording device is raised to 24, and the Absolute Time In Pregroove Error Rate (ATER) is reset to 0. Afterward, the data recording device start to writes to the recording media at the writing speed of 24.

Similarly, since the Absolute Time In Pregroove Error Rate (ATER) is not larger than the predetermined value when writing to the recording media at the writing speed of 24, the writing speed of the data recording device is raised to 32, and the Absolute Time In Pregroove Error Rate (ATER) is reset to 0. Afterward, the data recording device start to writes to the recording media at the writing speed of 32.

The error codes in Absolute Time In Pregroove (ATIP) are increased when writing to the recording media at the writing speed of 32. Since the Absolute Time In Pregroove Error Rate (ATER) is larger than the predetermined value at time 40, the writing speed of the data recording device is decreased to 24, and the Absolute Time In Pregroove Error Rate (ATER) is reset to 0. Afterward, the data recording device start to writes to the recording media at the writing speed of 24.

Note that, if the error codes in Absolute Time In Pregroove (ATIP) are still increased, the Absolute Time In Pregroove Error Rate (ATER) is further assessed to adjust the writing speed.

As a result, using the method for adjusting the writing speed of data recording devices, the writing speed can be dynamically adjusted according to the Absolute Time In Pregroove Error Rate (ATIP Error Rate, ATER) of recording media, so as to reduce writing failures.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method for adjusting the writing speed of a data recording device, comprising the steps of:
writing to a recording media at a first writing speed;
calculating the Absolute Time In Pregroove Error Rate (ATER) according to the error codes in Absolute Time In Pregroove (ATIP) on the recording media; and
decreasing the first writing speed to a second writing speed if the Absolute Time In Pregroove Error Rate (ATER) is larger than a predetermined value.

2. The method as claimed in claim 1 further comprising the step of writing to the recording media at the second writing speed after the second writing speed is set.

3. The method as claimed in claim 1 further comprising the step of calculating the Absolute Time In Pregroove Error Rate (ATER) after the second writing speed is set.

4. The method as claimed in claim 1 further comprising the step of raising the first writing speed to a third writing speed if the condition that Absolute Time In Pregroove Error Rate (ATER) is not larger than the predetermined value is maintained over a predetermined time period.

5. The method as claimed in claim 4 further comprising the step of writing to the recording media at the third writing speed after the third writing speed is set.

6. The method as claimed in claim 4 further comprising the step of resetting the Absolute Time In Pregroove Error Rate (ATER) after the third writing speed is set.

7. The method as claimed in claim 1 wherein the data recording device is a CD-R.

8. The method as claimed in claim 1 wherein the data recording device is a CD-RW.

9. The method as claimed in claim 1 wherein the recording media is a CD-R disc.

10. The method as claimed in claim 1 wherein the recording media is a CD-RW disc.

11. A method for adjusting the writing speed of a data recording device, at least comprising the steps of:
(a) writing to a recording media at a writing speed;
(b) calculating the Absolute Time In Pregroove Error Rate (ATER) of the recording media; and
(c) adjusting the writing speed according to the Absolute Time In Pregroove Error Rate (ATER).

12. The method as claimed in claim 11 wherein the step (c) further comprising the steps of:
decreasing the writing speed if the Absolute Time In Pregroove Error Rate (ATER) is larger than a predetermined value; and
raising the writing speed if the Absolute Time In Pregroove Error Rate (ATER) is not larger than the predetermined value.

13. The method as claimed in claim 11 further comprising the step of repeating the steps (a) to (c) until writing to the recording media is finished.

14. The method as claimed in claim 11 wherein the Absolute Time In Pregroove Error Rate (ATER) is calculated according to the error codes occurred in Absolute Time In Pregroove (ATIP) on the recording media.

15. The method as claimed in claim 11 further comprising the step of resetting the Absolute Time In Pregroove Error Rate (ATER) after the writing speed is adjusted.

16. The method as claimed in claim 11 wherein the data recording device is a CD-R.

17. The method as claimed in claim 11 wherein the data recording device is a CD-RW.

18. The method as claimed in claim 11 wherein the recording media is a CD-R disc.

19. The method as claimed in claim 11 wherein the recording media is a CD-RW disc.
